(19) United States
(12) Patent Application Publication
(10) Pub. No.: US 2008/0195999 A1
(43) Pub. Date: Aug. 14, 2008

(54) METHODS FOR SUPPLYING CODE ANALYSIS RESULTS BY USING USER LANGUAGE

(75) Inventors: Yossi Cohen, Raanana (IL); Mati Cohen, Raanana (IL); Tomer Konforty, Raanana (IL); Dror Weiss, Netanya (IL); Roy Armoni, Givat Ada (IL); Nir Marcu, Rishon Le-Zion (IL)

Correspondence Address: Active Knowledge Ltd., POB 294, Kiryat Tivon, 36010, omitted

(73) Assignee: Panaya Inc., Raanana (IL)

(21) Appl. No.: 11/956,477

(22) Filed: Dec. 14, 2007

Related U.S. Application Data
(60) Provisional application No. 60/900,720, filed on Feb. 12, 2007.
(60) Provisional application No. 60/912,706, filed on Apr. 19, 2007.

(51) Int. Cl. G06F 9/44

(52) U.S. Cl. 717/100

(57) ABSTRACT

Methods comprising the steps of receiving a code to be analyzed; running a flow analysis of the received code; running a backward and/or forward analysis, whereby the analysis returns at least one input statement; selecting at least one externally-visible statement from the returned list of statements; associating each externally-visible statement with its appropriate user-language description; and supplying a user the at least one user-language description that is associated with the externally-visible statement.

### BACKGROUND

The embodiments of the present invention relate to code analysis and, more particularly, to methods for supplying code analysis results by using user language.

Complete theoretical descriptions, details, explanations, examples, and applications of code analysis and related subjects are readily available in standard references in the fields of computer science.

### BRIEF SUMMARY

Some of the embodiments of the present invention comprise methods for mapping between elements of interest and user interface and/or methods for mapping between elements of interest and other functions that are known to the user. In other words, some of the embodiments comprise methods for connecting between elements of interest and user interface elements that represent the elements of interest from a user perspective, also referred to as user-language. As a result, the user is supplied with a user interface element instead of the known technical description, such as command lines, that may be supplied by prior art software applications.

For example, in order to represent an ‘IF’ statement in the user language, one embodiment may locate the User Interface (UI) element that is influenced by the IF statement or the UI element that is influencing the IF statement. In another example, instead of supplying a user with a reference to an SQL statement, one embodiment may supply the user with a GUI element that accesses the table referenced by the SQL statement.

In one embodiment, a user enters a query that runs an analysis of the system behavior and/or of the algorithmic behavior of the system. The analysis result is represented to the user by using UI elements that represent externally visible statements.

Without limiting the scope of the present invention, the terms “externally-visible statement”, “externally-visible input statement”, and “externally-visible output statement”, refer to any statement that uses or modifies a state that is external to the internal state of the program. For example: (1) Input and/or output statements, such as assignments to screen fields, database table access, file access, and error messages. (2) A statement in the program at which the control is transferred outside the program, such as, but not limited to, interface connection points in the code, also known as user exit. Specific examples of externally-visible statements include, but are not limited to: system screens, system reports, system configuration, user exit, interface to other systems, system flow, tables in the DB, and error messages.

Implementation of the methods for supplying code analysis results by using user language of the embodiments of the present invention involves performing or completing selected tasks or steps manually, semi-automatically, fully automatically, and/or a combination thereof. Moreover, depending upon actual instrumentation and/or equipment used for implementing an embodiment of the disclosed methods, several embodiments could be achieved by hardware, by software, by firmware, or a combination thereof. Additionally, or alternatively, with software, selected functions of the invention could be performed by a data processor, such as a computing platform, executing a software instructions or protocols using any suitable computer operating system.

### BRIEF DESCRIPTION OF THE DRAWINGS

The embodiments of the present invention are herein described, by way of example only, with reference to the accompanying drawings. With specific reference now to the drawings, it is stressed that the particulars shown are by way of example and for purposes of illustrative discussion of the embodiments of the present invention only.

FIG. 1 is a schematic illustration of one embodiment in accordance with the present invention;

FIG. 2A illustrates one flow analysis in accordance with the present invention;

FIG. 2B illustrates a table in accordance with the present invention;

FIG. 3 is a schematic illustration of another embodiment in accordance with the present invention;

FIGS. 4, 5A-C, and 6 are flowcharts illustrating backward analysis embodiments in accordance with the present invention;

FIG. 7 is a flowchart illustrating one forward analysis embodiment in accordance with the present invention;

FIGS. 8, 9, and 10A-B are flowcharts illustrating pointer graph analysis embodiments in accordance with the present invention; and

FIGS. 11A-11D illustrate user language embodiments in accordance with the present invention.

### DETAILED DESCRIPTION

The embodiments of the present invention are methods for supplying code analysis results by using user language. The embodiments are discussed in detail below. It is to be understood that the embodiments are not limited by the details of the order or sequence of steps of operation or implementation of the methods set forth in the following description, drawings or examples. While specific steps, configurations and arrangements are discussed, it is to be understood that this is done for illustrative purposes only. A person skilled in the relevant art will recognize that other steps, embodiments, configurations and arrangements can be used without departing from the spirit and scope of the present invention.

The embodiments of the present invention are capable of other embodiments or of being practiced or carried out in various ways. Also, it is to be understood that the phraseology, terminology, and notation employed herein are for the purpose of description and should not be regarded as limiting.

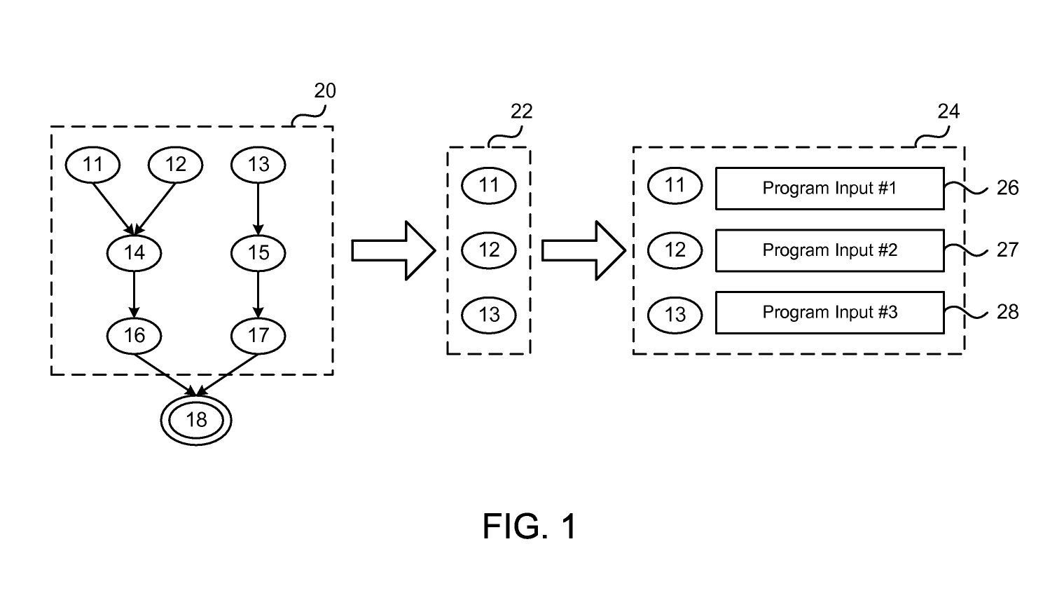

Referring to the figures, FIG. 1 is a general non-limiting illustration of one embodiment of a backward analysis method in accordance with the present invention. Statement 18 is selected to be analyzed by a backward analysis. The first step creates a backward slice graph 20, used for analyzing statement 18. The backward slice graph 20 includes statements 11-17. Optionally, statements 11-17 are represented by their identifiers in the analyzed code and/or any other alternative. The second step, referenced by 22, selects the externally-visible input statements (11, 12, and 13) from the list of statements 11-17. The third step, referenced by 24, adds user-language descriptions 26-28 to each externally-visible input statement (11, 12, and 13). Adding the user-language description enables a user of the system to easily understand and navigate within the analysis results.

Examples of user language descriptions and their corresponding statements, for backward analysis, include, but are not limited to: a screen that is used for updating a database table and its corresponding ‘select from table’ statement; and a screen that is used for writing to a file and its corresponding ‘read from file’ statement.

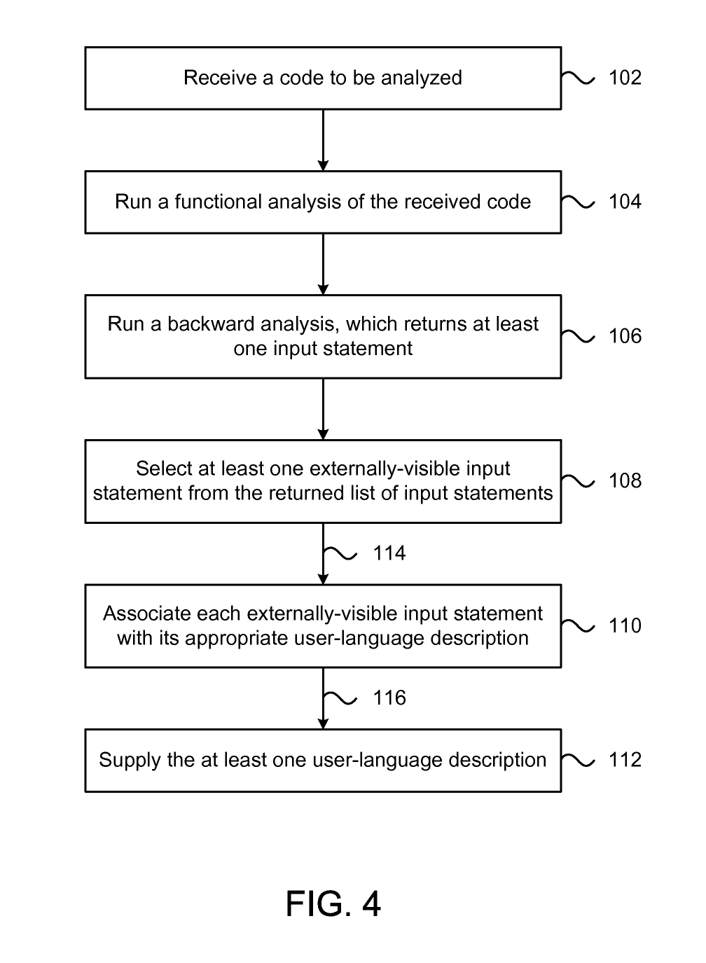

With reference to FIG. 4, one embodiment includes the following steps. Step 102 in FIG. 4 illustrates the step of receiving a code to be analyzed. Step 104 in FIG. 4 illustrates the step of running a flow analysis of the received code. In one embodiment, the outputs of the flow analysis are connections between specific statements in a code under examination and/or connections between specific variables in the code under examination and/or connections between specific hardware elements in hardware under examination, or a combination thereof. The connections are data dependencies or control dependencies. An example of a control dependency is an error message which depends on an ‘IF’ statement.

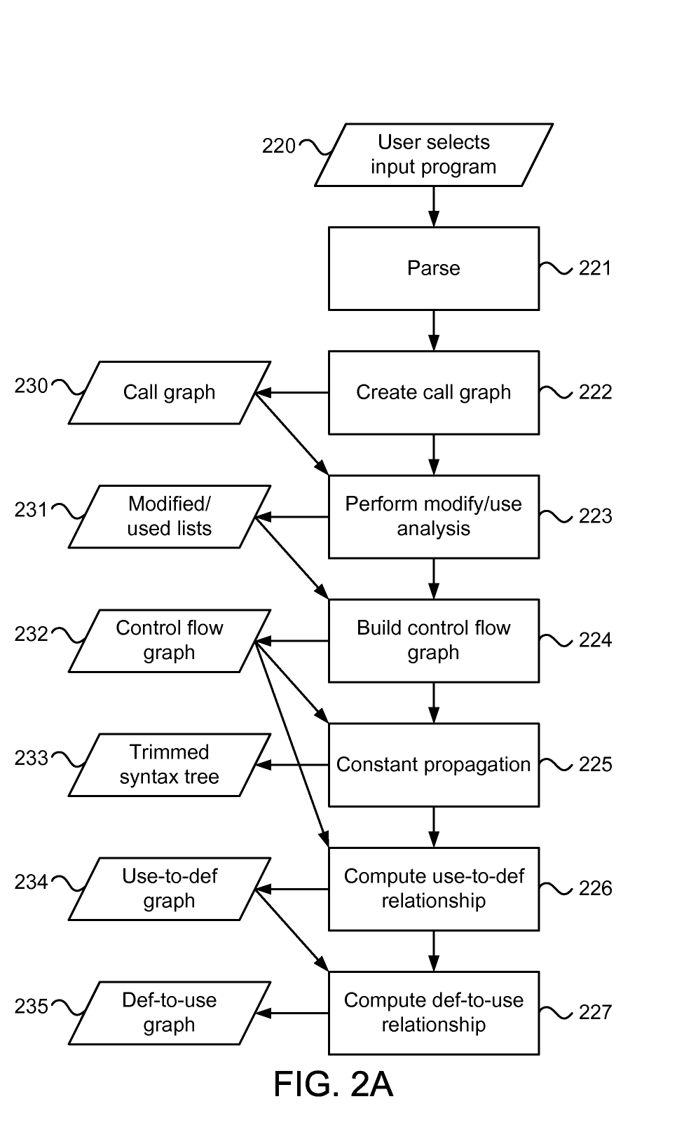

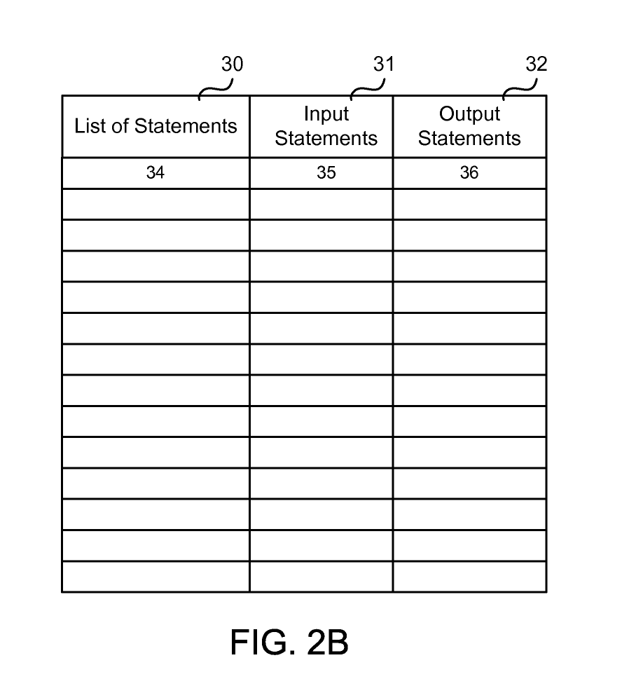

FIG. 2A is a non-limiting example of a flow analysis in accordance with the disclosed embodiments. It is to be understood that the disclosed embodiments are not limited to the steps illustrated in FIG. 2A, and that there are many other flow analysis embodiments that may be used by the disclosed embodiments. The flow analysis illustrated in FIG. 2A includes the steps of parsing the code 221, creating a call graph 222, performing modify/use analysis 223, building a control flow graph 224, constant propagation 225, computing use-to-def relationship 226, and computing def-to-use relationship 227. The process of FIG. 2A may create the following data structures: call graph 230, modified/used lists 231, control flow graph 232, trimmed syntax tree 233, use-to-def graph 234, and def-to-use graph 235. The illustrated process may be initialized by a user selecting an input program 220. The flow analysis may be implemented over a code or a graph that were sliced in advanced, as disclosed in other co-pending applications of the assignee of the present invention. For example, slicing the graph using constant propagation, and/or dead code elimination. The flow analysis step may be performed as a pre-processing step or on-demand.

In one embodiment, the flow analysis outputs a graph. Optionally, the graph represents the connections between statements in the analyzed code. By using the graph it is possible to go back from a statement to its externally-visible input statement and/or to go forward from the statement to its externally-visible output statement. Moreover, the graph may indicate all possible inputs and all possible outputs, or only a predefined set of inputs and outputs, or a group of inputs and outputs that is set dynamically.

Element 20 in FIG. 1 illustrates a graph. In one embodiment, the nodes of the graph represent statements. Without limiting the scope of the invention, the graph may be undirected or directed, and the edges may have no direction, be bidirectional or be unidirectional. By using the illustrated graph for analyzing statement 18, it is clear that statements 11, 12, and 13 are input statements to statement 18.

In one embodiment, the graph vertices are statements and the graph edges are variables. In another embodiment, the graph vertices are variables and the graph edges are statements, also known as a data flow graph.

In one embodiment, the externally-visible input statements and/or externally-visible output statements may be screens, forms, reports, or any other appropriate I/O elements. For example, in a SAP™ based system, the inputs and outputs may be forms.

Each statement in the program may be identified by its appropriate means. In one embodiment, each statement object may comprise a program name and a line number. Alternatively, each statement object may comprise a file name and a column number. Alternatively, each statement object may comprise a pointer to the source code. Those statement identifiers are useful for all kinds of code statements used in a graph, map or any other equivalents.

In one embodiment, the flow analysis outputs an index. Optionally, the index maps a first list of statements to a second list of statements, i.e. the index is a map between statements. Optionally, the index comprises at least one externally-visible input statement list and at least one externally-visible output statement list. Examples of externally-visible statements are: input statements, output statements, user exits, and a combination thereof. FIG. 2B is an example of a flow analysis index output having three columns: a list of statements 30, a list of input statements 31, and a list of output statements 32. As illustrated in FIG. 2B, statement 35 is the input statement to statement 34, and statement 36 is the output statement of statement 34.

Step 106 in FIG. 4 illustrates the step of running a backward analysis, whereby the backward analysis returns at least one input statement. The returned input statements are also known as a backward slice. In one embodiment, the backward analysis is initiated by a user entering a query to the system. Alternatively, the backward analysis query is entered to the system by a system. Optionally, the query defines the statement from which the backward analysis is derived.

Without limiting the scope of the present invention, a backward analysis may be defined as an analysis which determines properties of the input of a program from properties of the outputs.

The backward analysis, which also may be referred to as the backward slicing analysis, is processed by an appropriate system. In one embodiment, the backward analysis results in a list of input statements. In another embodiment, the backward analysis results in a list of variables. In still another embodiment, the backward analysis results in a set of hardware elements.

In one embodiment, processing the backward analysis includes the step of going backwards from the selected statement to its input statements by using functional dependencies, such as, but not limited to, use-to-def edges, also referred to as use-to-def relationships. The article “Representation and Analysis of Software”, by Mary Jean Harrold, Gregg Rothermel, and Alex Orso, Dec. 31, 2002, which is incorporated herein by reference, is an example of use-to-def.

Optionally, the step of running the backward analysis is initialized by receiving a starting statement from which the backward analysis starts. Examples of flow analysis methods in accordance with some embodiments of the invention are impact analysis, root cause analysis, and transaction investigation.

Step 108 in FIG. 4 illustrates the step of selecting at least one externally-visible input statement from the returned list of input statements. The criterion for classifying which input is an externally-visible input statement and which input is not an externally-visible input statement depends on the programming language and the application itself. For example, in ABAP™, the externally-visible input statements are selection statements and assignments to screen fields. Other examples for externally-visible input statements include: a read from file statement, a read from table statement, and a read from GUI statement.

Step 110 in FIG. 4 illustrates the step of associating each externally-visible input statement with its appropriate user-language description. Examples of user-language descriptions are user interface elements such as I/O, input console, and buttons. Optionally, an externally-visible statement may be associated with more than one user-language description.

The user language description is set according to the user and the environment. The following are non-limiting examples of externally-visible input statements and their user-language descriptions: (i) In a case where the externally-visible input statement is connected to a screen field or to a console, the user-language description of the input is the screen field or the console element. (ii) In a case where the externally-visible input statement is a read from a file/table input, the system is: Searching for statements that write to the file/table; And identifying the User interface (UI) elements that are associated with each statement that writes to the file/table.

In one embodiment the system is a hybrid software system having a hardware interface. The flow analysis may be performed as disclosed above but the user-language descriptions are hardware elements, such as read from a hardware input. For example, analyzing a hybrid system may include the following steps: Searching for statements and/or devices that determine the hardware settings; Identifying a User interface (UI) element and/or a device description that is associated with each statement and/or device that determine the hardware settings; And supplying the identified UI elements and/or device descriptions. Optionally, the identified UI elements are supplied to a user.

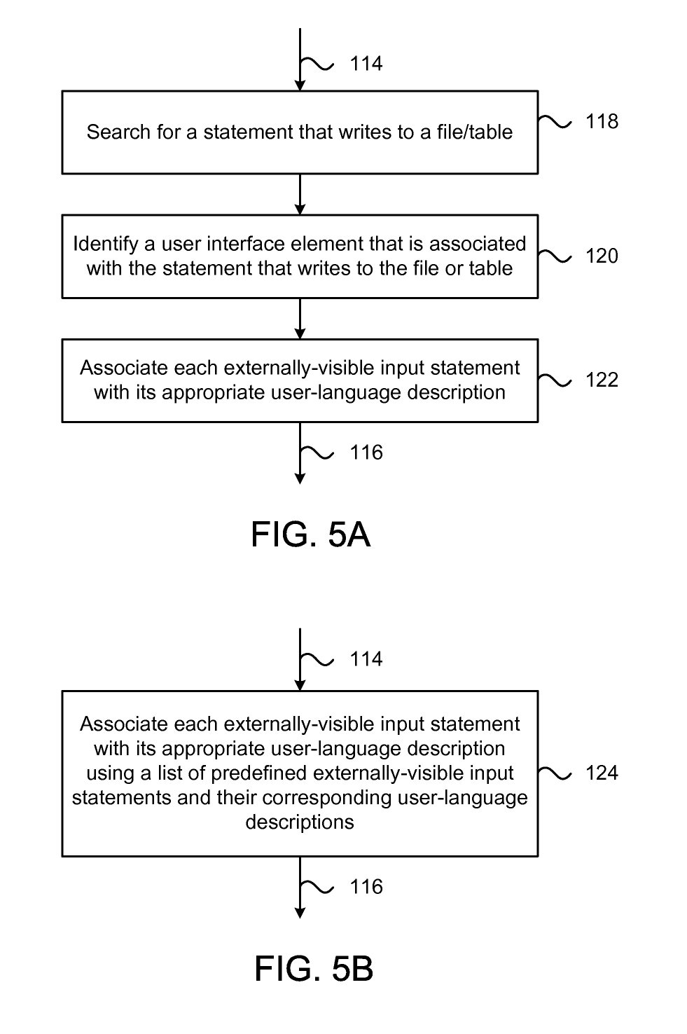

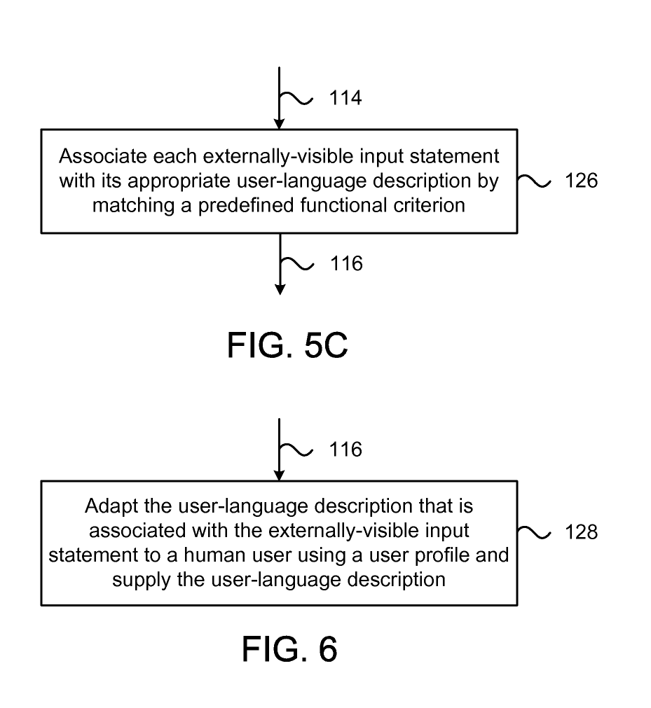

In one embodiment, step 110 of FIG. 4 may be replaced by the following steps illustrated in FIG. 5A: In step 118, searching for a statement that writes to the file or table; In step 120, identifying a user interface element that is associated with the statement that writes to the file or table; And in step 122, associating each externally-visible input statement with its appropriate user-language description.

In one embodiment, step 110 of FIG. 4 may be replaced by step 124, illustrated in FIG. 5B, which includes associating each externally-visible input statement with its appropriate user-language description using a list of predefined externally-visible input statements and their corresponding user-language descriptions.

According to another non-limiting example, identifying the user-language description may be achieved by using a list of predefined externally-visible input statements and their corresponding user-language descriptions. Alternatively, identifying the user-language description may be achieved by matching a predefined functional criterion, wherein the functional criterion is usually defined by the programming language used. Examples of functional criterions are: a criterion that uses data that is calculated in another statement; a statement whose operation depends on another statement, such as any statement in a procedure that depends on the act of calling the procedure. If the procedure is not called, all statements inside the procedure will not be executed.

In one embodiment, step 110 of FIG. 4 may be replaced by step 126, illustrated in FIG. 5C, which includes associating each externally-visible input statement with its appropriate user-language description by matching a predefined functional criterion.

Supplying the User-Language Description:

Step 112 in FIG. 4 illustrates the step of supplying at least one user-language description that is associated with the externally-visible input statement. The user-language description that is associated with the externally-visible input statement is supplied to a user. The user may be a human user or an artificial user, including an interface element that forwards the supplied statements to another system and/or user.

In one embodiment, step 112 of FIG. 4 may be replaced by step 128, illustrated in FIG. 6, which includes: adapting the user-language description that is associated with the externally-visible input statement to a human user, using a user profile, and supplying the user-language description.

Optionally, the user-language descriptions are supplied to a human user. Due to the fact that the user is supplied with the user-language descriptions instead of the statements as appear in the software code, the user is able to better understand and use the results. For example, all the statements resulting from the analysis are translated to UI elements.

In one embodiment, the user-language descriptions are adapted to specific users and/or groups of users. Optionally, each user is associated with a user profile which defines the elements that the user is familiar with, i.e. defines the user's language. In that case, the analysis results are phrased in the user language in accordance with the user's profile. For example, when the analyzed system features a user customized interface, the user-language description may be customized accordingly. Moreover, a user may sort the analysis results according to date, name, rank, and other parameters, for example, in order to receive only high ranked results. For example, the user language related to an error message includes the text of the error message and the externally-visible statement may be the related ABAP command which prints that error message.

In one embodiment, the user-language description results may be the only thing that is supplied to a user. For example, the user may be supplied with a list of user-language description results, or with groups of related user-language description results, or with the user-language description results separated by using tabs or other means.

Alternatively, the user-language description results may be supplied to the user using various methods, such as, but not limited to, the following embodiments.

In one embodiment, the user language-description supplied to the user is coupled with at least one statement. Optionally, the coupled statement represents the context and/or the functionality of the supplied result. For example, in the case where the input is a ‘select from table’, the user-language description may be a screen from which the user accesses the table.

In one embodiment, the user language description supplied to the user is coupled with at least one trace. Optionally, the trace includes code lines from a required statement to the supplied user-language description. For example, the trace may include GUI elements such as screens.

In one embodiment, the supplied user-language description is coupled with at least one graphical flow representation. The graphical flow representation may be a flow chart comprising code statements, and/or user-language description elements, and/or externally-visible statements. For example, the graphical flow representation may be implemented by one of the following embodiments: a flow chart comprising code statements; a flow chart comprising user-language description elements; and a flow chart comprising externally-visible statements.

In one embodiment, the user-language descriptions are screens, and the screens are classified according to their conceptual type. For example, the classification may be according to the associated screen or according to the type of the associated statement. The type of statement may be, but is not limited to, reading from a file, writing to table/file, showing an error message, calling user exit, etc.

For example, the classification may be according to the program in which the screens are stored. Moreover, screens which relate to the same transaction may be supplied together.

The user-language description may be supplied automatically while working with the software application. For example, an online opening of a screen which shows a result of an input; the fields in the screens may be taken from an offline DB so there is no need to change the software application.

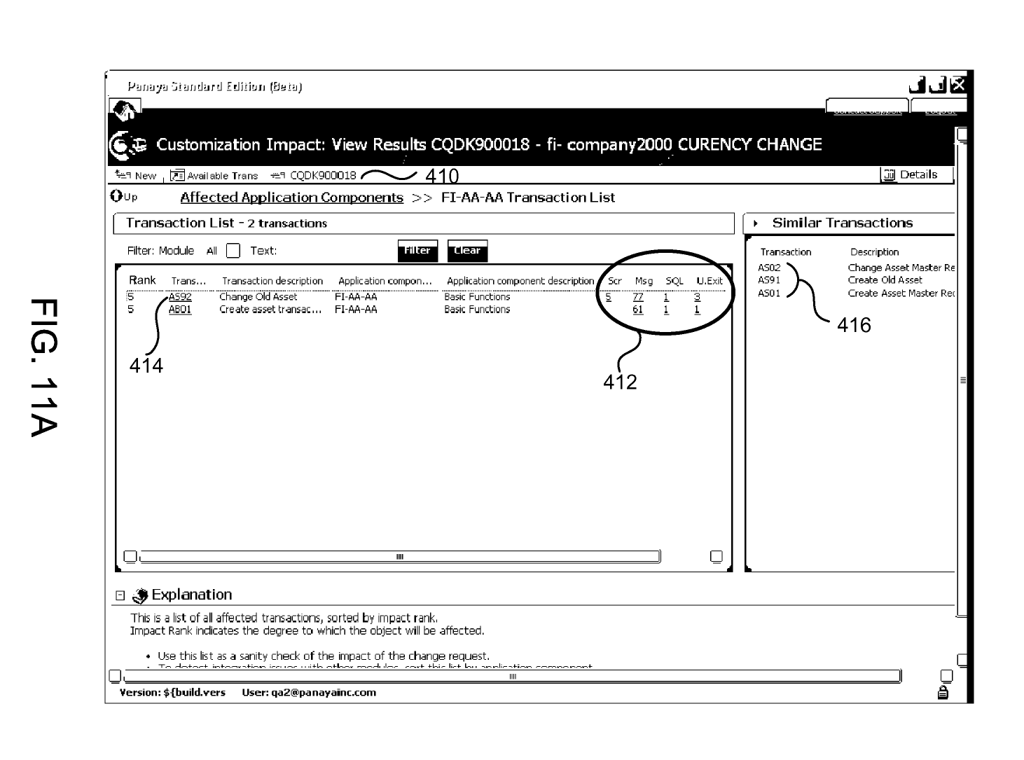

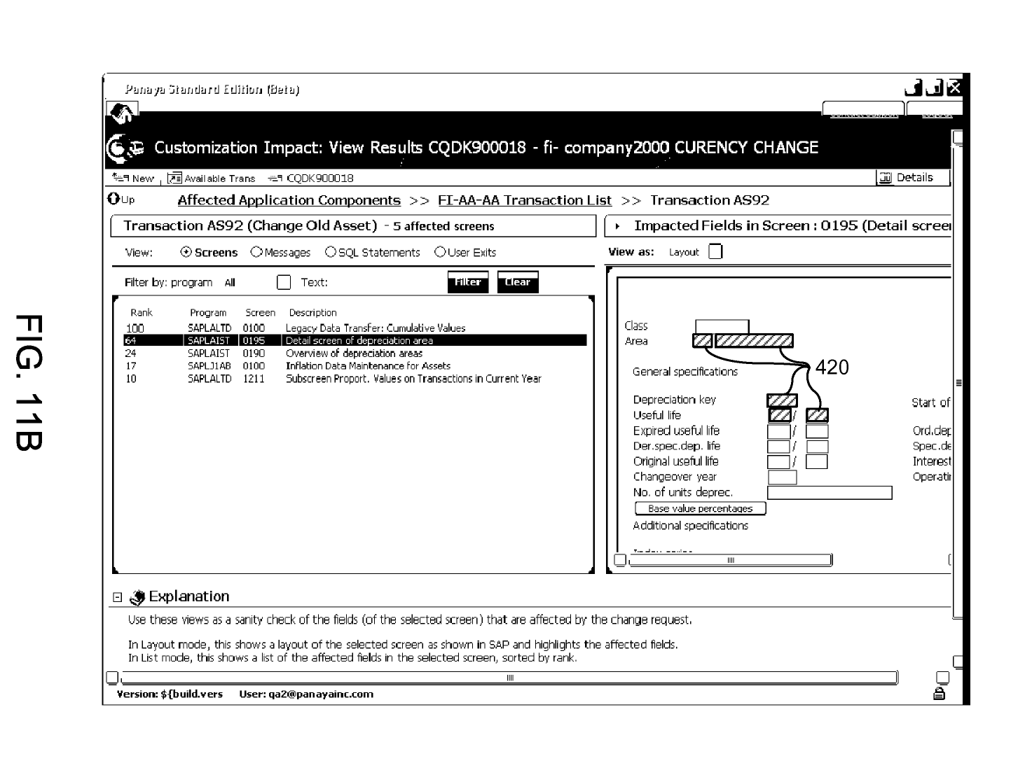

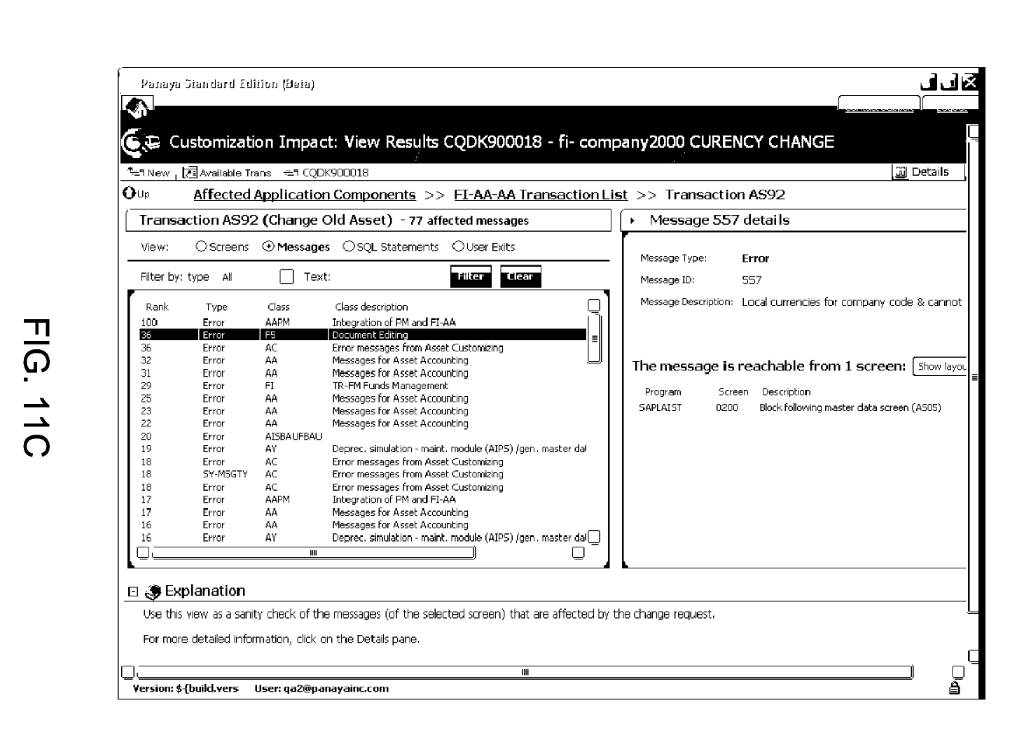

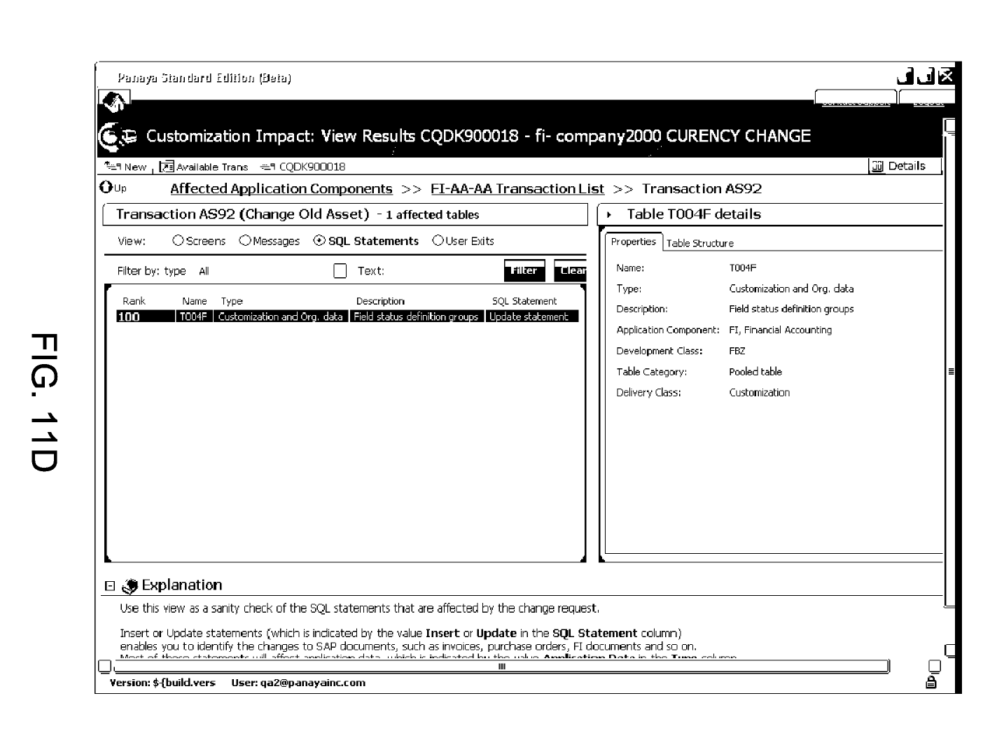

FIG. 11A illustrates a list of transactions (414 and 416) having the same impact 412. In this example, the change request is a change in at least one configuration table, such as adding, deleting, and/or updating some data in the table. Optionally, the change request representation illustrated in the figure may represent more than one change. Moreover, the user may be able to define the amount of changes that comprises the change request representation. For example, a first change request may include one change and a second change request may include a plurality of changes taken from different tables.

FIGS. 11A-11D illustrate an example, in the ABAP™ environment, of an analysis 410 which starts from select statements that read from a table containing the changes. The analysis starts from externally visible inputs, which are the values in the tables and/or the change requests, and provides the impact using externally visible outputs, which are the screen, messages, SQL statements, and user exits.

FIG. 11B illustrates the screens that are influenced by the change request in context of the specific transaction (AS92). On the right hand side, referenced by 420, the fields that are influenced by the specific transaction are highlighted. The right hand side is an example of a user language; the user language may be expressed as a function of the screen, messages, SQL statements, and/or user exits.

FIG. 11C illustrates an example where the user language is expressed by supplying the user with the text of a message instead of supplying the user with the command that caused the impact and generated the textual message.

FIG. 11D illustrates an example where the user language is expressed by supplying the user with the command that updates table T004F instead of supplying the user with the specific statement. Alternatively phrased, the figure illustrates a method for communicating with a user by utilizing text relevant to the table rather than text relevant to the specific command that actually reads the table. Other externally-visible outputs may include functions that are defined by the user. In this case, the user may be supplied with the name of the user exit, and the description may be SAP's description of the user exit.

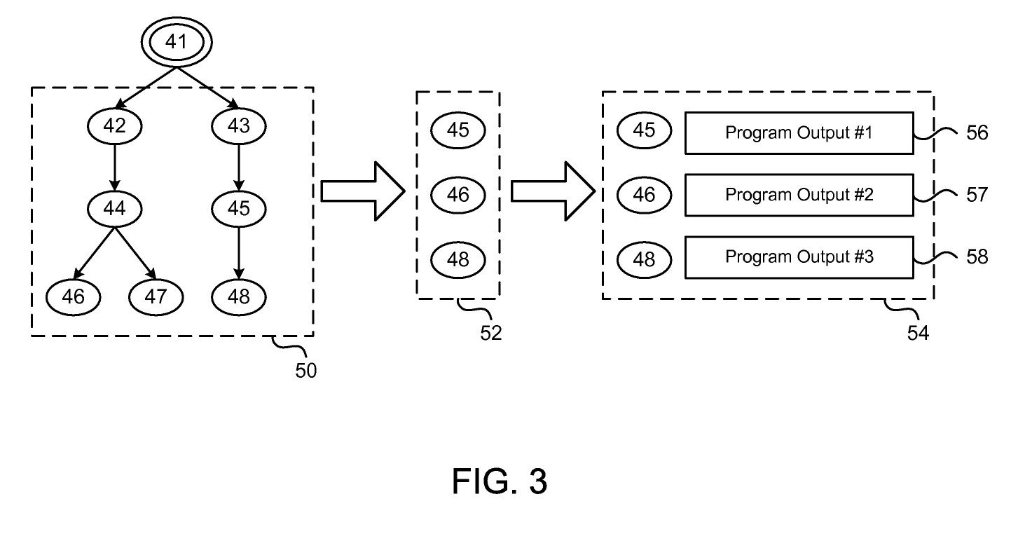

FIG. 3 is a general non-limiting illustration of one embodiment of a forward analysis method in accordance with the present invention. Statement 41 is a selected statement that is to be analyzed by the forward analysis. The first step creates a forward slice graph 50, used for analyzing statement 41. The forward slice graph 50 includes statements 42-48. Optionally, statements 42-48 are represented by their identifiers in the analyzed code and/or any other alternative.

The second step, referenced by 52, selects externally-visible output statements (45, 46, and 48) from the list of statements 42-48.

The third step, referenced by 54, adds user-language descriptions 56-58 to each externally-visible output statement (45, 46, and 48). Adding the user-language description enables a user of the system to easily understand and navigate within the analysis results. An example of a user-language description and its corresponding statement, for forward analysis, is an output element that is supplied to a user and its corresponding output command. An example of an output statement is a statement that outputs a message whereby its corresponding user language is the text of the output message.

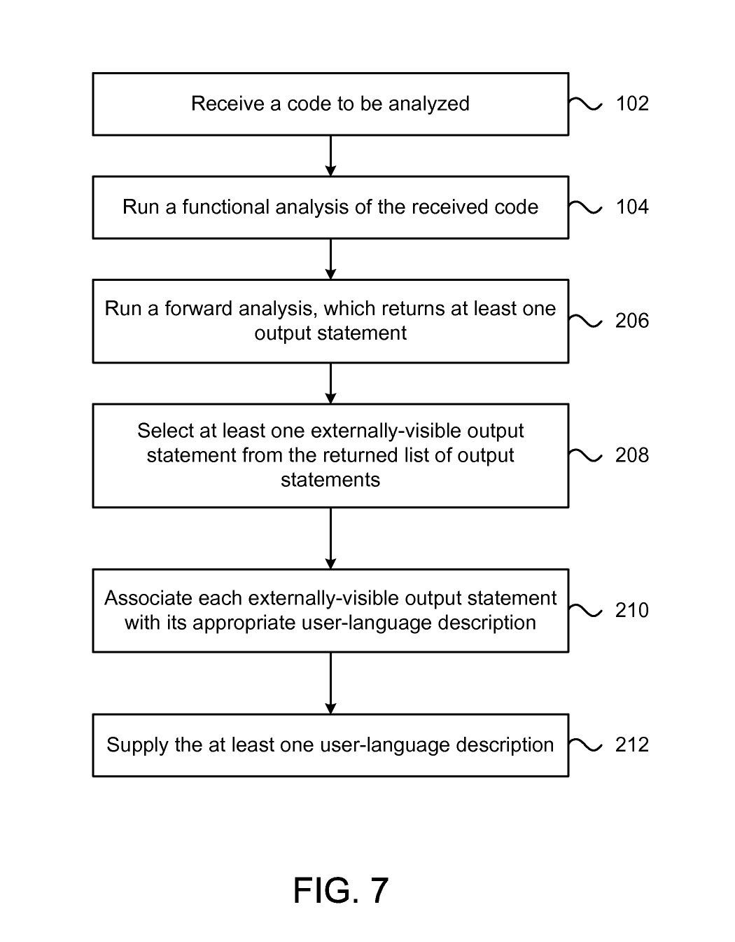

With reference to FIG. 7, one embodiment includes the following steps. Step 102 in FIG. 7 illustrates the step of receiving a code to be analyzed. Step 104 in FIG. 7 illustrates the step of running a flow analysis of the received code. Optionally, the step of running a flow analysis of the received code is performed as described above. In one embodiment, the flow analysis outputs a graph and the graph includes at least one externally-visible input statement and at least one externally-visible output statement. Optionally, the externally-visible statements are selected from the group of: input statements, output statements, user exits, and a combination thereof.

In one embodiment, the flow analysis outputs an index and the index includes at least one externally-visible input statement list and at least one externally-visible output statement list. Optionally, the externally-visible statements are selected from the group of: input statements, output statements, user exits, and a combination thereof.

Step 206 in FIG. 7 illustrates the step of running a forward analysis, whereby the forward analysis returns at least one output statement. The returned output statements may also known as a forward slice. In one embodiment, the forward analysis is initiated by a user entering a query to the system. Alternatively, the forward analysis query is entered to the system by a system. Optionally, the query defines the statement from which the forward analysis is derived. Without limiting the scope of the present invention, a forward analysis may be defined as an analysis which determines properties of the output of a program from properties of the inputs to the program. The forward analysis is processed by an appropriate system. In one embodiment, the forward analysis is a forward slicing analysis resulting in a list of output statements. In another embodiment, the forward analysis results in a list of variables. In still another embodiment, the forward analysis results in a set of hardware elements.

In one embodiment, the forward slicing analysis includes the step of going forwards from the selected input statement to its output statements by using functional dependencies, such as, but not limited to, def-to-use edges, which may also be referred to as def-to-use relationships. The article “Representation and Analysis of Software”, by Mary Jean Harrold, Gregg Rothermel, and Alex Orso, Dec. 31, 2002, which is incorporated herein by reference, is an example of def-to-use. Additionally and/or alternatively, it is possible to track the edges of the control flow graph. In one embodiment, the step of running the forward analysis further includes the step of receiving a starting statement from which the forward analysis is initialized.

Step 208 in FIG. 7 illustrates the step of selecting at least one externally-visible output statement from the returned list of output statements. The criterion for classifying which output is an externally-visible output statement and which output is not an externally-visible output statement depends on the programming language and the application itself. For example, in ABAP™, the externally-visible output statements may be assignments to screen fields, file and DB accesses, error messages, and user exit calls.

Step 210 in FIG. 7 illustrates the step of associating each externally-visible output statement with its appropriate user-language description. In order to express the externally-visible output statement in the user terminology, each output statement is associated with one or more interface element that the user experiences when executing the selected statement, also referred to as a user-language description. Examples of user-language descriptions are screens and transactions. For example, in SAP™ environment, the output statements may be associated to screens and transactions. For example, a screen field may be associated with the screen it appears in; other output statements may be associated with a screen from which they are executed.

For example, the user-language description of a specific statement may be obtained from the following sources: (i) The semantics of the specific statement, i.e. describing the statement by using the way the statement is executed and not by using the programmer statement identifier. For example, instead of displaying “if(perm==write)”, display “the file does not have a ‘write’ permission”. (ii) Reading a user-language description from a data-base. The user-language description data-base may be customized according to a specific need, a user profile, and/or execution environment. Moreover, the user-language description data-base may also be implemented by a file, table, list, etc.

According to another non-limiting example, identifying the user-language description may be achieved by using a list of predefined externally-visible output statements and their corresponding user-language descriptions. Alternatively, identifying the user-language description may be achieved by matching a predefined functional criterion, wherein the functional criterion is usually defined by the programming language used.

Step 212 in FIG. 7 illustrates the step of supplying at least one user-language description that is associated with the externally-visible output statement. The user-language description that is associated with the externally-visible output statement is supplied to a user. The user may be a human user or an artificial user, including an interface element that forwards the supplied statements to another system and/or user. This step is further detailed above in the section titled “SUPPLYING USER LANGUAGE DESCRIPTION”, and it is to be understood that all above described embodiments may be applicable to this set of embodiments.

In one embodiment, the output of the flow analysis is a pointer-based data structure which enables a user to investigate the pointer-based data structure without using a forward slicing analysis and/or a backward slicing analysis, as disclosed hereinbelow.

Referring back to the drawings, FIG. 8 is a general non-limiting illustration of one embodiment of a method in accordance with the present invention.

Step 102 in FIG. 8 illustrates the step of receiving a code to be analyzed.

Step 304 in FIG. 8 illustrates the step of running a flow analysis of the received code, wherein the flow analysis is outputting a pointer graph. Optionally, the pointer graph represents the connections between variables in the analyzed code. By using the pointer graph it is possible to go back from a variable to its externally-visible input variable and/or to go forward from the variable to its externally-visible output variable. Moreover, the pointer graph may indicate all possible inputs and all possible outputs, or only a predefined set of inputs and outputs, or a group of inputs and outputs that is set dynamically.

The pointer graph includes vertices and edges. The vertices may include variables and the edges may include connections between pointing variables and pointed variables. The variables may be externally-visible input or output variables.

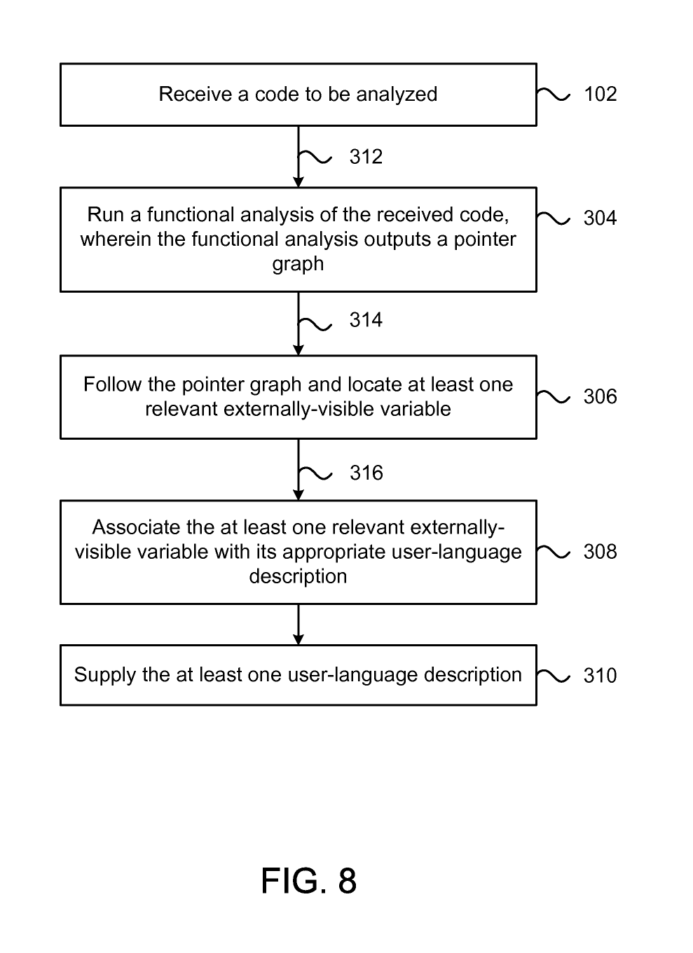

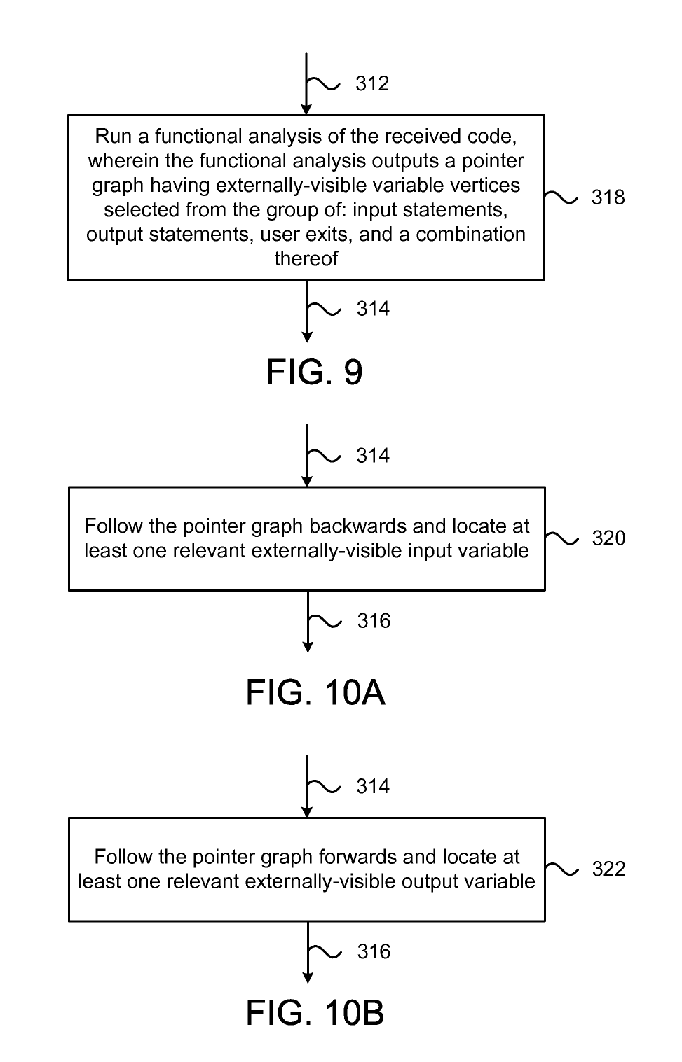

In one embodiment, step 304 of FIG. 8 may be replaced by step 318, illustrated in FIG. 9, which includes running a flow analysis of the received code, wherein the flow analysis is outputting a pointer graph having externally-visible variable vertices selected from the group of: input statements, output statements, user exits, and a combination thereof. The term externally-visible input variable as used herein denotes a variable that is used by an externally-visible input statement. The term externally-visible output variable as used herein denotes a variable that is defined by an externally-visible output statement.

In one embodiment, the variables are memory locations. In that case, the pointer graph comprises memory locations vertices and connections between pointing and pointed memory locations edges.

It is to be understood that the flow analysis may be implemented over a code or a graph that were sliced in advance, as disclosed in other co-pending applications of the assignee of the present invention.

The flow analysis step may be performed as a pre-processing step or on-demand.

Step 306 in FIG. 8 illustrates the step of following the pointer graph and locating at least one relevant externally-visible variable. The criterion for classifying which variables are relevant externally-visible variables and which variables are not relevant externally-visible variables, depends on the programming language and the application itself. For example, in ABAP™, externally-visible variables are variables defined by select statements and assignments to screen fields. Optionally, the step of following the pointer graph further includes the step of receiving a starting node from which the process is initialized.

In one embodiment, step 306 of FIG. 8 may be replaced by step 320, illustrated in FIG. 10A, which includes following the pointer graph backwards and locating at least one relevant externally-visible input variable.

In one embodiment, step 306 of FIG. 8 may be replaced by step 322, illustrated in FIG. 10B, which includes following the pointer graph forwards and locating at least one relevant externally-visible output variable.

Step 308 in FIG. 8 illustrates the step of associating a relevant externally-visible variable with its appropriate user-language description.

Step 310 in FIG. 8 illustrates the step of supplying at least one user-language description that is associated with at least one relevant externally-visible variable. In one embodiment, the user-language description that is associated with the externally-visible variable is supplied to a user. The user may be a human user or an artificial user, including an interface element that forwards the supplied variable to another system and/or user.

This step is further detailed above in the section titled “SUPPLYING THE USER LANGUAGE DESCRIPTION”, and it is to be understood that all above described embodiments may be applicable to this set of embodiments.

It is appreciated that certain features of the embodiments, which are, for clarity, described in the context of separate embodiments, may also be provided in various combinations in a single embodiment. Conversely, various features of the embodiments, which are, for brevity, described in the context of a single embodiment, may also be provided separately or in any suitable sub-combination.

While the methods disclosed herein have been described and shown with reference to particular steps performed in a particular order, it will be understood that these steps may be combined, sub-divided, or reordered to form an equivalent method without departing from the teachings of the embodiments of the present invention. Accordingly, unless specifically indicated herein, the order and grouping of the steps is not a limitation of the embodiments of the present invention.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A computer-implemented method comprising:
receiving a code to be analyzed;
running a flow analysis of the received code;
running a backward analysis, whereby the backward analysis returns at least one input statement;
selecting at least one externally-visible input statement from the returned list of input statements;
associating each externally-visible input statement with its appropriate user-language description; and
supplying the at least one user-language description that is associated with the externally-visible input statement.

2. The method of claim 1, wherein the at least one user-language description is supplied to a human user and further comprising the step of adapting the user-language description to the human user.

3. The method of claim 1, wherein the at least one user-language description supplied is coupled with at least one of the following: a statement, trace, and a graphical flow representation.

4. The method of claim 1, wherein the at least one user-language description supplied is coupled with at least one graphical flow representation, and the graphical flow representation comprises at least one of the following: a flow chart comprising code statements, user-language description elements, and a flow chart comprising externally-visible statements.

5. The method of claim 1, wherein the flow analysis is outputting a graph or an index; the graph comprises at least one externally-visible input statement and at least one externally-visible output statement; wherein the externally-visible statements are selected from the group of: input statements, output statements, user exits, and a combination thereof.

6. The method of claim 1, wherein the externally-visible input statement is selected from the group of: a read from file statement, a read from table statement, a read from GUI statement, and a combination thereof.

7. The method of claim 1, wherein the step of associating each externally-visible input statement with its appropriate user-language description, when the externally-visible input statement is a read from a file or read from a table, comprises the steps of: searching for a statement that writes to the file or table; and identifying the user interface element that is associated with the statement that writes to the file or table; whereby the identified user interface element is used for the user-language description.

8. The method of claim 1, wherein the step of associating each externally-visible input statement with its appropriate user-language description comprises at least one of the following steps: utilizing a list of predefined externally-visible input statements and their corresponding user-language descriptions, and identifying the user-language description by matching a predefined functional criterion.

9. A computer-implemented method comprising:
receiving a code to be analyzed;
running a flow analysis of the received code;
running a forward analysis, whereby the forward analysis returns at least one output statement;
selecting at least one externally-visible output statement from the returned list of output statements;
associating each externally-visible output statement with its appropriate user-language description; and
supplying the at least one user-language description that is associated with the externally-visible output statement.

10. The method of claim 9, further comprising the step of adapting the user-language description to a human user, and the at least one user-language description supplied is coupled with at least one of the following: a statement, a trace, a graphical flow representation, a flow chart comprising code statements, a flow chart comprising user-language description elements, and a flow chart comprising externally-visible statements.

11. The method of claim 9, wherein the user-language descriptions are screens, and the screens are classified according to their conceptual type.

12. The method of claim 9, wherein the flow analysis is outputting a graph and the graph comprises at least one externally-visible input statement and at least one externally-visible output statement, whereby the externally-visible statements are selected from the group of: input statements, output statements, user exits, and a combination thereof.

13. The method of claim 9, wherein the flow analysis is outputting an index and the index comprises at least one externally-visible input statement list and at least one externally-visible output statement list, whereby the externally-visible statements are selected from the group of: input statements, output statements, user exits, and a combination thereof.

14. The method of claim 9, wherein the user-language description is selected from the group of screens and transactions and the step of associating each externally-visible output statement with its appropriate user-language description comprises using the semantics of the externally-visible output statement.

15. A computer-implemented method comprising:
receiving a code to be analyzed;
running a flow analysis of the received code, wherein the flow analysis is outputting a pointer graph;
following the pointer graph and locating at least one relevant externally-visible variable;
associating the at least one relevant externally-visible variable with its appropriate user-language description; and
supplying the at least one user-language description that is associated with the at least one externally-visible variable.

16. The method of claim 15, further comprising the step of adapting the user-language description to a human user, and wherein the at least one user-language description supplied is coupled with at least one of the following: a variable, a trace, a graphical flow representation, a flow chart comprising user-language description elements, and a flow chart comprising externally-visible variables.

17. The method of claim 15, wherein the user-language descriptions are screens, and the screens are classified according to their conceptual type.

18. The method of claim 15, wherein the pointer graph comprises vertices and edges, wherein the vertices comprise variables and the edges comprise connections between pointing variables and pointed variables; at least one of the variables is an externally-visible variable selected from the group of: input variables, and output variables.

19. The method of claim 15, wherein the step of following the pointer graph comprises following the pointer graph backwards and locating at least one externally-visible input variable.

20. The method of claim 15, wherein the step of following the pointer graph comprises following the pointer graph forwards and locating at least one externally-visible output variable.

21. A computer-implemented method comprising:
receiving a flow analysis of a code;
running a code analysis, whereby the code analysis returns a list of statements;
selecting at least one externally-visible statement from the returned list of statements;
receiving a user-language description for each selected externally-visible statement; and
supplying the received user-language descriptions.

22. The method of claim 21, further comprising the step of adapting the user-language description to a human user, and supplying the user-language description coupled with at least one of the following: a statement, a trace, and a graphical flow representation.

23. The method of claim 21, wherein the user-language descriptions are screens, and the screens are classified according to their conceptual type.

24. The method of claim 21, wherein the code analysis is a backward slicing analysis and the returned list of statements is a list of input statements.

25. The method of claim 21, wherein the code analysis is a forward slicing analysis and the returned list of statements is a list of output statements.
